(19) United States
(12) Patent Application Publication
(10) Pub. No.: US 2025/0373747 A1
(43) Pub. Date: Dec. 4, 2025

(54) IMAGE READING APPARATUS THAT SETS CARRIAGE AT HOME POSITION, AND IMAGE FORMING APPARATUS

(71) Applicant: KYOCERA Document Solutions Inc., Osaka (JP)

(72) Inventor: Trung Manh TRAN, Osaka (JP)

(73) Assignee: KYOCERA Document Solutions Inc., Osaka (JP)

(21) Appl. No.: 19/220,370

(22) Filed: May 28, 2025

(30) Foreign Application Priority Data
Jun. 4, 2024 (JP) 2024-090976

(51) Int. Cl. H04N 1/10; H04N 1/028

(52) U.S. Cl. CPC H04N 1/1039; H04N 1/02815; H04N 2201/0081; H04N 2201/0448

(57) ABSTRACT

An image reading apparatus includes a carriage, a drive mechanism, an imaging device, a controller, and a first white reference plate. The controller controls the drive mechanism, thereby moving the carriage to a search start position, located on a side of a document setting region with respect to a region occupied by the first white reference plate, decides, on a basis of image data on an outer side of the document setting region in the main scanning direction, sequentially read by the imaging device while the carriage is being moved in a first direction, from the search start position toward the region occupied by the first white reference plate, whether a read image is white, and positions the carriage at a home position, by moving the carriage from a position thereof when the read image was decided as white, by a predetermined distance in the first direction.

### INCORPORATION BY REFERENCE

This application claims priority to Japanese Patent Application No. 2024-090976 filed on Jun. 4, 2024, the entire contents of which are incorporated by reference herein.

### BACKGROUND

The present disclosure relates to an image reading apparatus that reads a document placed on a contact glass, and an image forming apparatus incorporated with such image reading apparatus.

Existing image reading apparatuses generally include a contact glass for placing a document, a carriage, and an image sensor. The carriage includes a light source that emits light to the document placed on the contact glass, along a main scanning direction, and is located on the lower side of the contact glass, opposite to the upper face on which the document is placed, so as to reciprocate along a sub scanning direction orthogonal to the main scanning direction. The image sensor receives the light emitted from the light source and reflected by the document, thereby reading the image of the document placed on the contact glass.

The carriage is made to move in the sub scanning direction, by a drive mechanism, for example including a stepping motor as drive source. The image reading apparatus controls the action of the stepping motor, so as to perform an initial operation of positioning the carriage at a prespecified position, in other words the home position, and then move the carriage in the sub scanning direction, to read the image of the document placed on the contact glass.

To set the carriage at the home position, the image reading apparatus includes a single-purpose sensor, such as a photo interrupter (PI) sensor, to detect that the carriage has reached the home position. However, it is undesirable that the number of parts increases. In the case of a low-end model, in particular, it is essential to save the cost. Accordingly, various techniques have thus far been proposed, to set the carriage at the home position, without depending on the single-purpose sensor such as the PI sensor.

### SUMMARY

The disclosure proposes further improvement of the foregoing technique.

In an aspect, the disclosure provides an image reading apparatus including a contact glass, a carriage, a drive mechanism, an imaging device, a controller, an outer peripheral member, and a first white reference plate. On the contact glass, a document is placed. The carriage includes a light source that emits light to the document placed on the contact glass, along a main scanning direction, and reciprocates along a sub scanning direction orthogonal to the main scanning direction, the carriage being located on a lower side of the contact glass, opposite to an upper face on which the document is placed. The drive mechanism moves the carriage in the sub scanning direction. The imaging device reads an image of the document placed on the contact glass, by receiving the light emitted from the light source and reflected. The controller includes a processor, and moves, when the processor executes a control program, the carriage in the sub scanning direction, thereby causing the imaging device to read the image of the document placed on the contact glass, by controlling an action of the light source, the drive mechanism, and the imaging device. The outer peripheral member is located along an outer periphery of the contact glass. The first white reference plate is located inside a region occupied by the contact glass, with longitudinal sides extending in the main scanning direction, and overlaps with the outer peripheral member in a plan view. The first white reference plate is located at a position between an end portion of the contact glass and a document setting region on the contact glass, in the sub scanning direction. In a case of positioning the carriage at a home position, defined inside a region occupied by the first white reference plate in the sub scanning direction, after causing the imaging device to read the image of the document placed on the contact glass, the controller controls the action of the drive mechanism, thereby moving the carriage to a predetermined search start position, located on a side of the document setting region with respect to the region occupied by the first white reference plate, and stopping the carriage at the search start position, executes, while moving the carriage in a first direction, from the search start position toward the region occupied by the first white reference plate, a first deciding operation including deciding, on a basis of image data on an outer side of the document setting region in the main scanning direction, sequentially read by the imaging device, whether a read image represented by the image data is white, and positions the carriage at the home position, by stopping the carriage after moving the carriage from a position thereof when the read image was decided as white in the first deciding operation, by a predetermined first distance, corresponding to a length between a side edge of the first white reference plate on the side of the document setting region in the first direction, and the home position.

In another aspect, the disclosure provides an image forming apparatus including the foregoing image reading apparatus, and an image forming device. The image forming device forms the image acquired through the reading operation of the image reading apparatus, on a recording sheet.

### BRIEF DESCRIPTION OF THE DRAWINGS

FIG. 1 is a perspective view showing the appearance of an image forming apparatus, incorporated with an image reading apparatus according to an embodiment of the disclosure;

FIG. 2A is a schematic cross-sectional front view showing a document feeding device and a document reading device;

FIG. 2B is a schematic plan view showing the document reading device;

FIG. 3 is a cross-sectional view of the document reading device, taken along a line III-III in FIG. 2B;

FIG. 4 is a functional block diagram showing an essential internal configuration of the image forming apparatus;

FIG. 5 is a schematic drawing for explaining an example of positioning control, to set a carriage at a home position;

FIG. 6 is a table showing relations between average values of image data of respective colors, and black/white decision results;

FIG. 7 is a flowchart showing an example of a positioning operation for setting the carriage at the home position;

FIG. 8 is a schematic drawing specifying an example of a repositioning operation to again set the carriage at the home position;

FIG. 9 is a schematic drawing for explaining an example of a control process for setting the carriage at a home position search start position;

FIG. 10 is a schematic drawing specifying an example of a positioning operation for setting the carriage at the home position; and

FIG. 11 is a schematic drawing for explaining another example of the control process for setting the carriage at the home position search start position.

### DETAILED DESCRIPTION

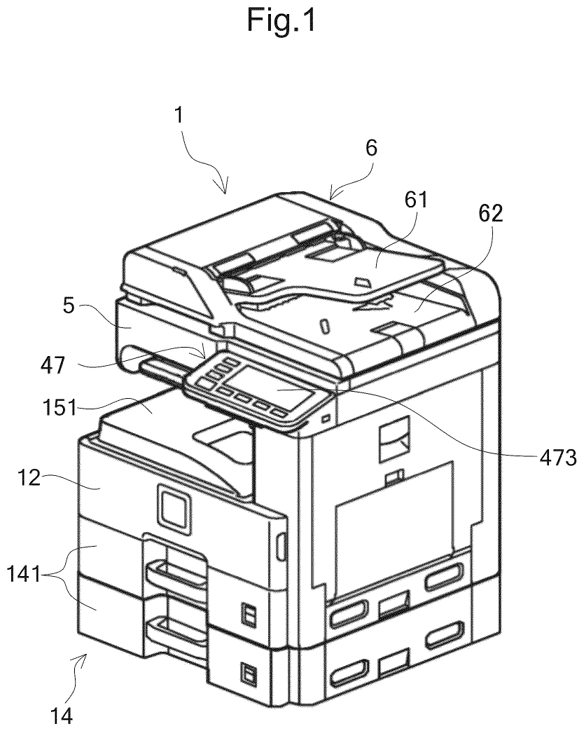

Hereafter, an image reading apparatus and an image forming apparatus according to an embodiment of the disclosure will be described, with reference to the drawings. FIG. 1 is a perspective view showing the appearance of the image forming apparatus 1, incorporated with the image reading apparatus according to the embodiment of the disclosure.

The image forming apparatus 1 is a multifunction peripheral having a plurality of functions, such as copying, printing, scanning, and facsimile transmission. The image forming apparatus 1 includes a document feeding device 6, a document reading device 5, an image forming device 12, a sheet feeding device 14, and an operation device 47.

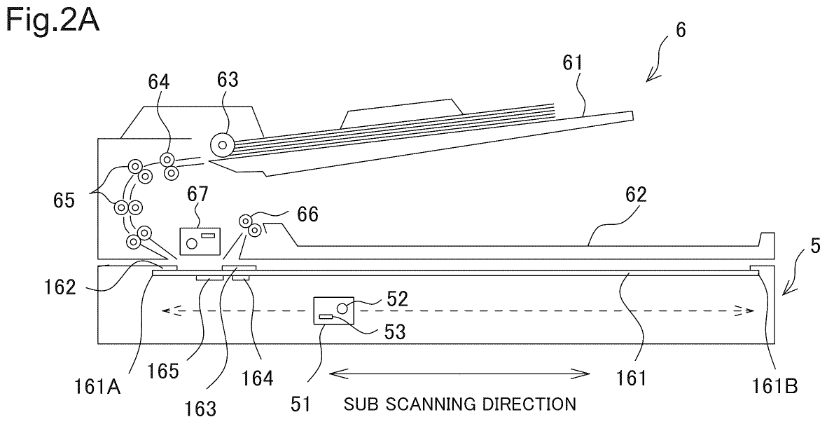

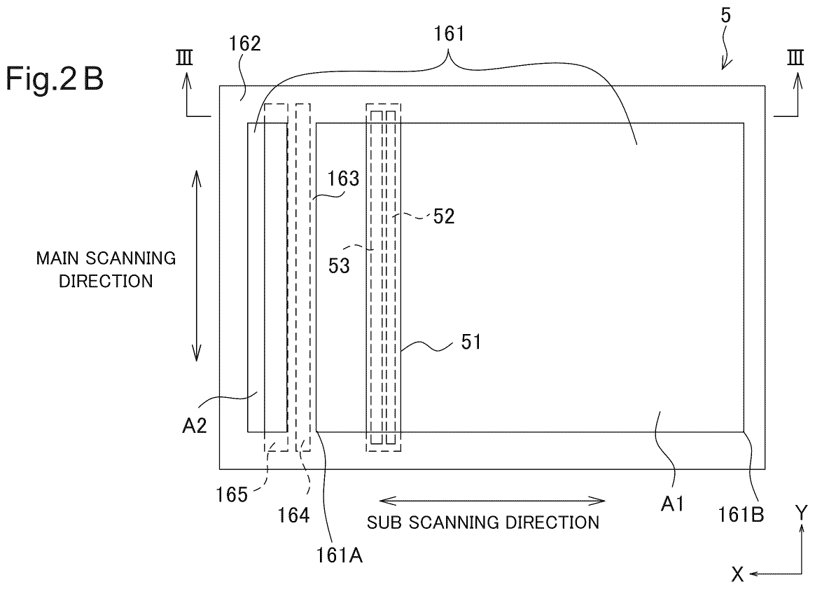

The document feeding device 6 is openably connected to the upper face of the document reading device 5, for example via a hinge. The document feeding device 6 serves as a document retention cover, when a document placed on a contact glass 161 (see FIG. 2A and FIG. 2B), which will be subsequently described, is to be read. The document feeding device 6 also includes a document tray 61 on which the document is placed, and a document discharge tray 62 provided on the lower side of the document tray 61. The document feeding device 6 feeds the documents placed on the document tray 61 one by one to the document reading device 5, and discharges the document to the document discharge tray 62.

The document reading device 5 includes a scanner. The document reading device 5 reads the document delivered from the document feeding device 6, or the document placed on the contact glass 161. The document reading device 5 can sequentially read a plurality of documents delivered from the document feeding device 6.

To perform the document reading operation, the image forming apparatus 1 operates as follows. The document reading device 5 optically reads the image on the document delivered from the document feeding device 6 to the document reading device 5, or placed on the contact glass 161, and generates image data. The image data generated by the document reading device 5 is stored, for example, in an image memory.

To perform the image forming operation, the image forming apparatus 1 operates as follows. The image forming device 12 includes a photoconductor drum, a charging device, an exposure device, a developing device, and a primary transfer device for each of the colors. The image forming device 12 includes a mechanism that forms an image on a recording sheet, by secondary transfer via an intermediate transfer belt. The image forming device 12 forms a toner image on the recording sheet delivered from the sheet feeding device 14, thereby producing a printed material, on the basis of the image data generated through the document reading operation, image data stored in the image memory, or image data received from a computer connected via the network.

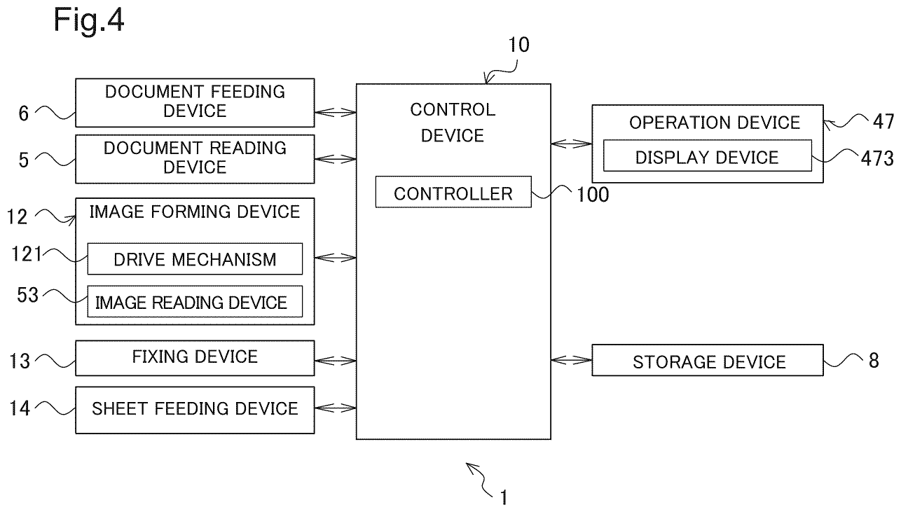

The recording sheet on which the toner image has been formed by the image forming device 12 is subjected to a fixing operation by a fixing device 13 (see FIG. 4) to be subsequently described. The recording sheet that has undergone the fixing operation is delivered to an output tray 151.

The sheet feeding device 14 includes a plurality of sheet cassettes 141. The sheet feeding device 14 also includes a pickup roller, transport rollers, a transport route, and rotational drive mechanism for the rollers, to pick up the recording sheet from the sheet cassette 141 and transport the recording sheet to the image forming device 12.

The operation device 47 includes various hard keys to be operated by the user. The operation device 47 receives the user's instructions inputted with the hard keys, to execute the functions and operations that the image forming apparatus 1 is configured to perform, for example the image forming operation. For example, the operation device 47 can receive a document reading instruction (scanning instruction, or copying instruction).

The operation device 47 includes a display device 473 for displaying, for example, an operation guide for the user. The operation device 47 receives, through a touch panel provided on the display device 473, the user's instruction based on the touch operation performed by the user on the screen displayed on the display device 473.

The display device 473 includes, for example, a liquid crystal display (LCD). The display device 473 includes a touch panel. When the user touches a button or a key displayed on the screen, the touch panel receives the instruction corresponding to the touched position. In this case, the touch panel acts as a part of the operation device.

FIG. 2A is a schematic cross-sectional front view showing the document feeding device 6 and the document reading device 5. FIG. 2B is a schematic plan view showing the document reading device 5. The document reading device 5 includes the contact glass 161, an outer peripheral member 162, a first white reference plate 164, a second white reference plate 165, and a carriage 51.

The carriage 51 includes a light source 52, and an imaging device 53. The light source 52 emits light, along a main scanning direction, to the document placed on a document setting region A1 of the contact glass 161, or document transported by the document feeding device 6 and passing the contact glass 161 (moving document reading region A2).

The imaging device 53 reads the image of the document placed on the document setting region A1, or the image of the document passing the contact glass 161 (moving document reading region A2), by receiving the light emitted from the light source 52 and reflected. The imaging device 53 is, for example, an image sensor such as a contact image sensor (CIS).

Hereinafter, the direction in which the imaging device 53 extends (longitudinal direction of the imaging device 53, corresponding to the Y-direction in FIG. 2B) will be defined as the main scanning direction, and the direction orthogonal to the main scanning direction (travel direction of the carriage 51, corresponding to the X-direction in FIG. 2B) will be defined as a sub scanning direction.

Now, an end portion of the contact glass 161 in the sub scanning direction will be defined as one end portion 161A, and the end portion on the opposite side will be defined as the other end portion 161B. The document setting region A1 refers to a region in the contact glass 161 on the side of the other end portion 161B in the sub scanning direction, with respect to a separator 163 and the first white reference plate 164.

The carriage 51 is configured to reciprocate along a rail, in the sub scanning direction orthogonal to the main scanning direction. The carriage 51 is made to move in the sub scanning direction by a known drive mechanism 121 (see FIG. 4), for example including a stepping motor, as the drive source.

The document feeding device 6 includes a document tray 61, a document discharge tray 62, a sheet feeding roller 63, a resist roller 64, a plurality of transport rollers 65, a discharge roller 66, and a back-face reading unit 67.

The back-face reading unit 67, configured to read a back-face image of the document delivered from the document feeding device 6, includes a light source and an image sensor, like the carriage 51. The image sensor of the back-face reading unit 67 reads the back-face image of the document, while the image sensor of the carriage 51 reads the front-face image of the document, and therefore the carriage 51 may be regarded as a front-face reading unit, as opposed to the back-face reading unit 67.

The outer peripheral member 162 is located along the outer edge of the contact glass 161. The outer peripheral member 162 includes a separator 163 that separates the contact glass 161 into the document setting region A1 and the moving document reading region A2.

The first white reference plate 164 and the second white reference plate 165 are white-colored plates, representing a predetermined tone to be used for shading correction. The first white reference plate 164 is allocated for the carriage 51, which is the front-face reading unit, and the second white reference plate 165 is allocated for the back-face reading unit 67.

The first white reference plate 164 is located on the lower side of the separator 163. In other words, the first white reference plate 164 is located on the side of the end portion 161A of the contact glass 161 (left side in FIG. 2A and FIG. 2B) in the sub scanning direction, with respect to the document setting region A1. The first white reference plate 164 has the longitudinal sides extending in the main scanning direction, and overlaps with the outer peripheral member 162 in a plan view.

The first white reference plate 164 is located at a position between the end portion 161A of the contact glass 161, and the document setting region A1 of the contact glass 161, in the sub scanning direction.

The second white reference plate 165 is spaced from the first white reference plate 164 in the sub scanning direction, and located on the side of the end portion 161A of the contact glass 161, with respect to the first white reference plate 164. The second white reference plate 165 has the longitudinal sides extending in the main scanning direction, and overlaps with the outer peripheral member 162 in a plan view.

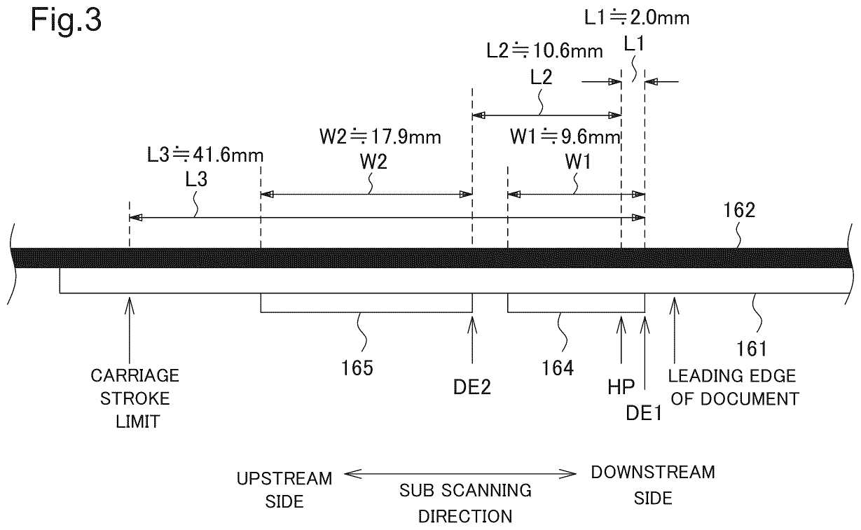

FIG. 3 is a cross-sectional view of the document reading device 5, taken along a line III-III in FIG. 2B. A width W1 represents the width of the first white reference plate 164 in the sub scanning direction (e.g., 9.6 mm), and a width W2 represents the width of the second white reference plate 165 in the sub scanning direction (e.g., 17.9 mm).

A home position HP is defined at the position where the first white reference plate 164 is located in the sub scanning direction (inside the region occupied by the first white reference plate). In this embodiment, the home position HP is defined at the position shifted by a predetermined distance, corresponding to a length L1, from an end portion DE1 of the first white reference plate 164 on the side of the document setting region A1, in the sub scanning direction (e.g., 2.0 mm). A length L2 represents the distance between the home position HP and an end portion DE2 of the second white reference plate 165 on the side of the document setting region A1 (e.g., 10.6 mm). A length L3 represents the length between the stroke limit of the carriage 51 in the sub scanning direction, on the side of the end portion 161A of the contact glass 161, and the end portion DE1 of the first white reference plate 164 on the side of the document setting region A1 (e.g., 41.6 mm).

FIG. 4 is a functional block diagram schematically showing an essential internal configuration of the image forming apparatus 1. The image forming apparatus 1 includes a control device 10, the document feeding device 6, the document reading device 5, the image forming device 12, a fixing device 13, the sheet feeding device 14, the operation device 47, and a storage device 8.

The image forming device 12 includes a drive mechanism 121 that moves the carriage 51 (see FIG. 2A and FIG. 2B) in the sub scanning direction, and the imaging device 53.

The fixing device 13 includes a heat roller, a pressure roller, and a drive mechanism therefor. The fixing device 13 heats and presses the recording sheet on which the toner image has been formed by the image forming device 12, at the nip region defined between the mentioned rollers, to thereby fix the toner image onto the recording sheet. The recording sheet that has undergone the fixing process is delivered to the output tray 151 (see FIG. 1).

The storage device 8 is a large-capacity storage device such as a hard disk drive (HDD) and a solid-state drive (SSD). The storage device 8 contains various control programs.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU).

The control device 10 acts as a controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 47, and the storage device 8, and controls the operation of the mentioned components.

For example, the controller 100 controls the action of the light source 52, the drive mechanism 121, and the imaging device 53, thereby moving the carriage 51 in the sub scanning direction, and causing the imaging device 53 to read the image of the document placed on the contact glass 161. The controller 100 also controls the action of the image forming device 12 and the related components, so as to execute various operations necessary for the image forming apparatus 1 to form an image.

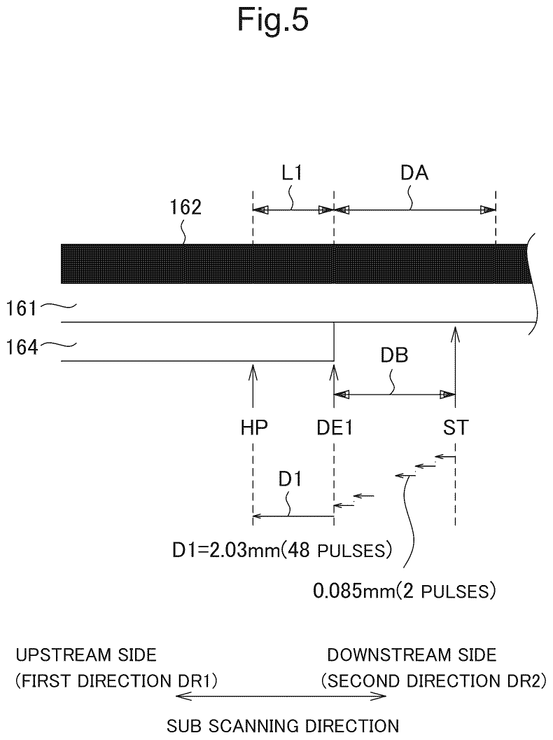

FIG. 5 is a schematic drawing for explaining an example of positioning control, to set the carriage 51 at the home position. To set the carriage 51 at the home position HP, the controller 100 controls the action of the drive mechanism 121, to move the carriage 51 to a predetermined home position search start position ST, a predetermined distance DA (e.g., 4 mm) away from the end portion DE1 of the first white reference plate 164 in the sub scanning direction, and stop the carriage 51 at this position. Thus, the carriage 51 is positioned at the home position search start position ST. In this embodiment, the home position search start position ST is spaced from the end portion DE1 of the first white reference plate 164 on the downstream side, by a distancer DB (≤ distance DA).

Then the controller 100 executes, while moving the carriage 51 in a first direction DR1, from the home position search start position ST toward the end portion DE1 of the first white reference plate 164 (upstreamwise direction), a first deciding operation including deciding, on the basis of the image data on the outer side of the document setting region A1 in the main scanning direction (e.g., outer side of the line III-III in FIG. 2B), sequentially read by the imaging device 53, whether the read image represented by such image data is white.

The controller 100 executes the first deciding operation using the imaging device 53 (e.g., CIS), the reading region of which extends to the position overlapping with the outer peripheral member 162 in a plan view, for example on the basis of pixel values of each of the color components (red, green, blue) of the read image. In other words, the controller 100 does not utilize the entirety of the image read by the imaging device 53, but only a part thereof.

The read image presents a color other than white of the first white reference plate 164, for example black, until the carriage 51 reaches the end portion DE1 of the first white reference plate 164. In other words, when the read image presents the white color, it can be assumed that the carriage 51 has reached the downstream-side end portion DE1 of the first white reference plate 164.

For example, when the distance DB is approximately 3 mm and the travel distance of the carriage 51 per drive pulse of the motor of the drive mechanism 121 is 0.042328 mm, and two pulses drive the motor by one step, the travel distance of the carriage 51 per step is approximately 0.085 mm, and therefore the carriage 51 reaches the downstream-side end portion DE1 of the first white reference plate 164, by being made to move 36 times (3 mm≈0.085×36).

To decide whether the read image is white, the controller 100 calculates the average values of the image data of the respective color components (red, green, blue) acquired from the imaging device 53 (CIS), and decides whether the average values are equal to or higher than a predetermined threshold, thereby deciding whether the read image is white, on the basis of such decision result.

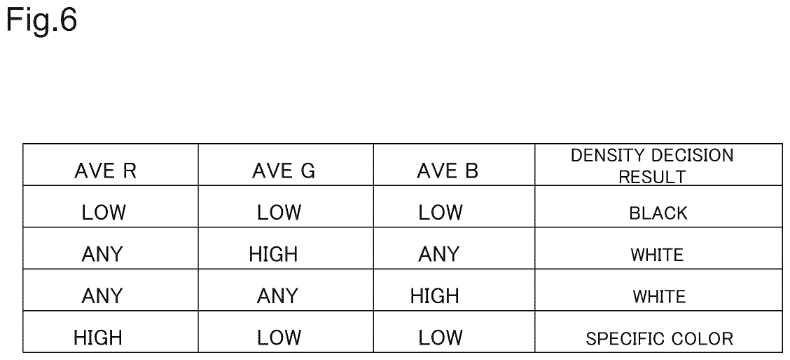

FIG. 6 is a table showing relations between the average values of image data of the respective colors, and black/white decision results. The term “Low” in FIG. 6 indicates that the average value is below the threshold, the term “High” indicates that the average value is equal to or higher than the threshold, and the term “Any” in FIG. 6 indicates that the threshold is not applicable. As may be apparent from the table shown in FIG. 6, when, for example, the average value of the green image data (Ave G) is “High”, and the average value of the blue image data (Ave B) is “High”, the read image is decided to be white.

The controller 100 stops the carriage 51, after moving the carriage 51 in the first direction DR1 by a predetermined first distance D1 (corresponding to the length L1 between the end portion DE1 of the first white reference plate 164 and the home position HP), from the position where the carriage 51 was located when the read image was decided as white (downstream-side end portion DE1 of the first white reference plate 164), and defines the position where the carriage 51 has been stopped as the home position HP, thus positioning the carriage 51. When the length L1 is approximately 2 mm, the controller 100 moves the carriage 51 by 48 pulses (2 mm≈0.042328×48).

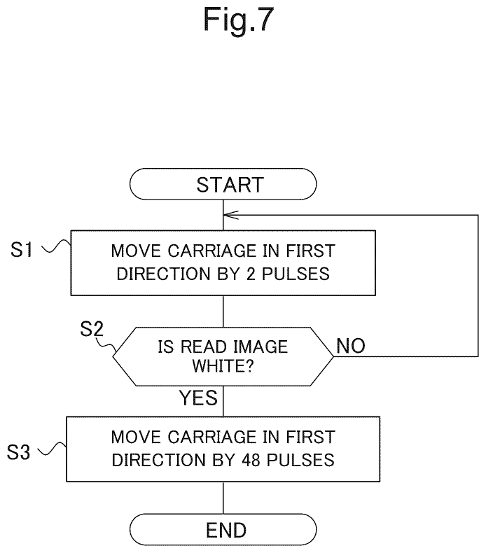

Referring now to a flowchart shown in FIG. 7, the positioning operation for setting the carriage 51 at the home position HP, performed by the control device 10 of the image forming apparatus 1, will be described hereunder. This positioning operation is performed when the controller 100 locates the carriage 51 at the home position search start position ST, after causing the imaging device 53 to read the image of the document placed on the document setting region A1 of the contact glass 161.

While moving the carriage 51 from the home position search start position ST in the first direction DR1 (upstreamwise direction), the controller 100 decides, on the basis of the image data on the outer side of the document setting region A1 in the main scanning direction, sequentially read by the imaging device 53, whether the read image represented by such image data is white.

First, the controller 100 drive mechanism 121 to move the carriage 51 by 2 pulses in the first direction DR1 (upstreamwise direction) (step S1). Then the controller 100 controls the action of the imaging device 53 to acquire the image data on the outer side of the document setting region A1, and decides whether the read image represented by the image data is white (step S2).

When the read image is decided as white (YES at step S2), it can be assumed that the carriage 51 has reached the downstream-side end portion DE1 of the first white reference plate 164. Therefore, the controller 100 controls the action of the drive mechanism 121, to move the carriage 51 from the position thereof when the read image was decided as white, by 48 pulses in the first direction DR1 (upstreamwise direction) (step S3). The position that the carriage 51 has reached after such movement is defined as the home position HP. After step S3, the controller 100 finishes the positioning operation.

In contrast, when the read image is decided as not being white (NO at step S2), it is assumed that the carriage 51 has not reached the downstream-side end portion DE1 of the first white reference plate 164. Therefore, the controller 100 returns to step S1, to control the action of the drive mechanism 121 so as to move the carriage 51 by 2 pulses in the first direction DR1. Thereafter, the controller 100 repeats the operation of step S2.

Hereunder, a repositioning operation for again setting the carriage 51 at the home position HP will be described. The repositioning operation is performed after the carriage 51 is stopped at the home position HP, through the mentioned positioning operation, and before the imaging device 53 is made to read the image of the document placed on the document setting region A1 of the contact glass 161 (e.g., before the image forming apparatus 1 is shifted to a normal mode (standby mode) from an energy-saving mode).

Because of the action of the drive mechanism 121 controlled by the controller 100 as above, the carriage 51 is located at the home position HP through the positioning operation, at the timing immediately after the image reading operation is finished. When the controller 100 shifts the operation mode of the image forming apparatus 1 to the energy-saving mode, and then to the normal mode (standby mode) in this state, the carriage 51 is supposed to be located at the home position HP. However, the carriage 51 may be slightly displaced in the sub scanning direction, during the energy-saving mode. Accordingly, when the operation mode is shifted to the normal mode, the controller 100 again positions the carriage 51 at the home position HP, before causing the imaging device 53 to read the image of the document placed on the document setting region A1.

In the case of performing the repositioning operation, the controller 100 decides, on the basis of the image data on the outer side of the document setting region A1 in the main scanning direction, read by the imaging device 53, whether the read image represented by such image data is white. Upon deciding that the read image is white, as result of the mentioned decision, the controller 100 moves the carriage 51 in the first direction DR1, by a predetermined second distance D2 (longer than the length L2 between the home position HP and the end portion DE2 of the second white reference plate 165, but shorter than the sum of the length L2 and the width W2 of the second white reference plate 165 in the sub scanning direction), and stops the carriage 51.

Then the controller 100 decides, on the basis of the image data on the outer side of the document setting region A1 in the main scanning direction, read by the imaging device 53, whether the read image represented by such image data is white. Upon deciding that the read image is white, the controller 100 moves the carriage 51 in a second direction DR2, opposite to the first direction DR1, by a predetermined third distance D3 (longer than the sum of the second distance D2 and the length L1) and stops the carriage 51, and defines the stop position as the home position search start position ST. Then the controller 100 executes the positioning operation specified in FIG. 7, thereby setting the carriage 51 at the home position HP.

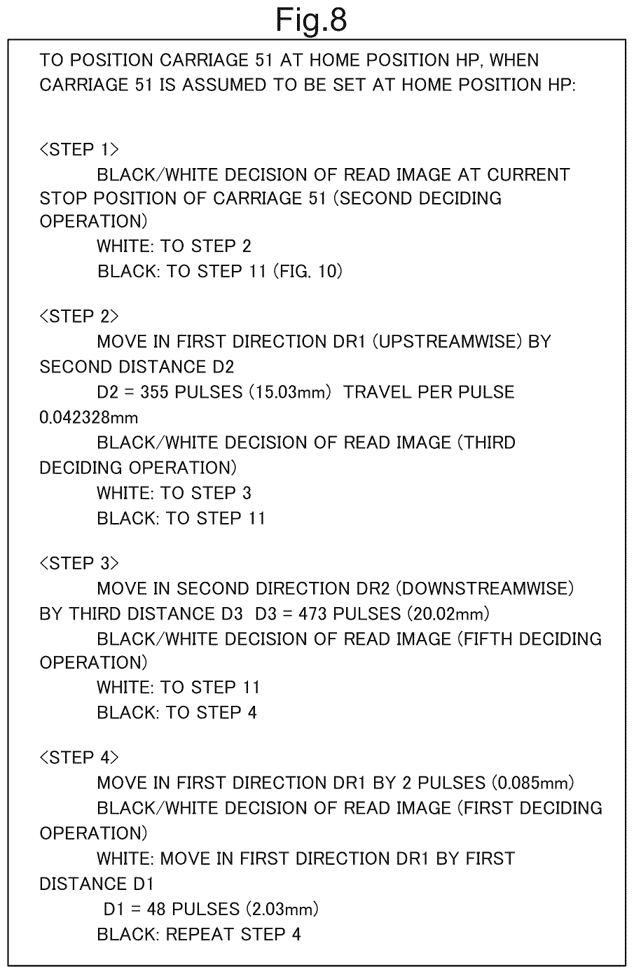

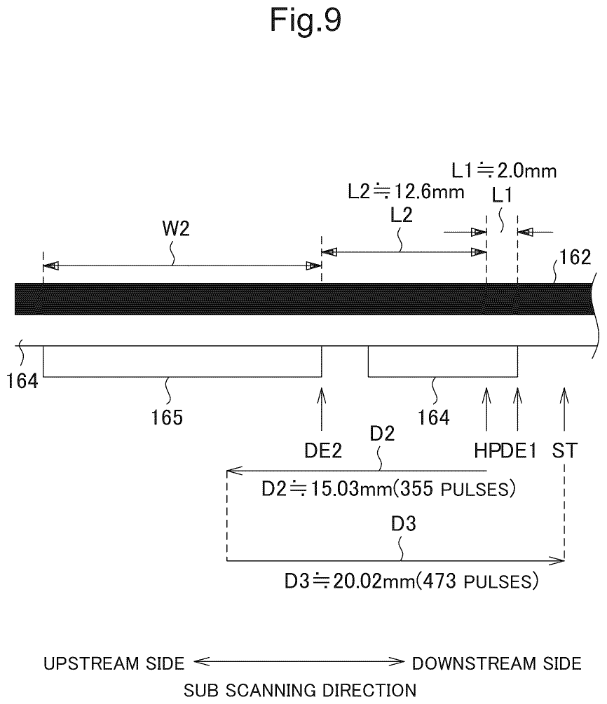

FIG. 8 is a schematic drawing specifying an example of a repositioning operation, including again setting the carriage 51 at the home position, after the carriage 51 is stopped at the home position HP as above, and before causing the imaging device 53 to read the image of the document placed on the document setting region A1 of the contact glass 161. FIG. 9 is a schematic drawing for explaining an example of the control process for setting the carriage 512 at the home position search start position ST.

### Step 1

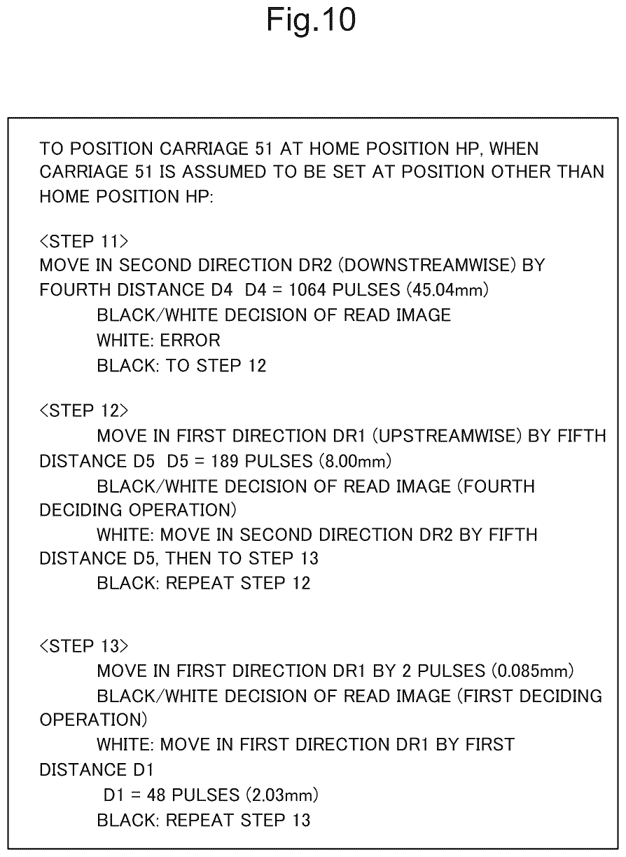

The controller 100 performs black/white decision (second deciding operation) with respect to the read image acquired at the current position of the carriage 51, and proceeds to step 2 in the case of white, and proceeds to step 11 (see FIG. 10) to be subsequently described, in the case of black.

### Step 2

The controller 100 moves the carriage 51 in the first direction DR1 by the second distance D2 (355 pulses). Then the controller 100 performs the black/white decision (third deciding operation) with respect to the read image, and proceeds to step 3 in the case of white, and proceeds to step 11 in the case of black.

### Step 3

The controller 100 moves the carriage 51 in the second direction DR2 by the third distance D3 (473 pulses). Then the controller 100 performs the black/white decision (fifth deciding operation) with respect to the read image, and proceeds to step 11 in the case of white, and proceeds to step 4 in the case of a color other than white, for example black (it can be assumed that the carriage 51 has reached the home position search start position ST).

### Step 4

The controller 100 moves the carriage 51 in the first direction DR1 by 2 pulses. Then the controller 100 performs the black/white decision (first deciding operation) with respect to the read image, and moves the carriage 51 in the first direction DR1 by the first distance D1 (48 pulses), in the case of white (it can be assumed that the carriage 51 has reached the downstream-side end portion DE1 of the first white reference plate 164). As result, the positioning of the carriage 51 at the home position HP is completed. In the case of black, the controller 100 repeats the operation of step 4.

Hereunder, the repositioning operation, for again setting the carriage 51 at the home position HP will be described. This operation is performed, when it is uncertain whether the carriage 51 has been stopped at the home position HP (e.g., the power to the image forming apparatus 1 is turned on, from off).

When it is uncertain, as mentioned above, whether the carriage 51 has been stopped at the home position HP, and therefore the repositioning operation of the carriage 51 has to be performed, the controller 100 moves the carriage 51 in the second direction DR2 by a predetermined fourth distance D4 (longer than the length L3 between the end portion 161A of the contact glass 161 and the end portion DE1 of the first white reference plate 16 on the side of the document setting region A1), and stops the carriage 51. Accordingly, the controller 100 locates the carriage 51 on the side of the document setting region A1, with respect to the first white reference plate 164.

Then the controller 100 moves the carriage 51 in the first direction DR1 by a predetermined fifth distance D5 (shorter than the width W1 of the first white reference plate 164 in the sub scanning direction), and performs a fourth deciding operation including deciding, on the basis of the image data on the outer side of the document setting region A1, read by the imaging device 53, whether the read image represented by such image data is white. Upon deciding that the read image is not white through the fourth deciding operation, the controller 100 again moves the carriage 51 in the first direction DR1 by the fifth distance D5, and again performs the fourth deciding operation.

In contrast, upon deciding that the read image is white through the fourth deciding operation, the controller 100 again moves the carriage 51 in the second direction DR2 by the fifth distance D5 and stops the carriage 51, and defines the stop position as the home position search start position ST. Then the controller 100 executes the positioning operation specified in FIG. 7, thereby setting the carriage 51 at the home position HP.

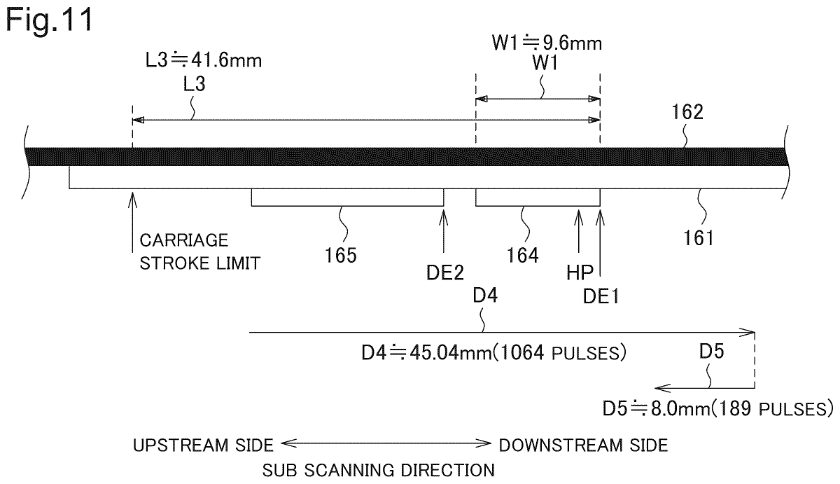

FIG. 10 is a schematic drawing specifying an example of a positioning operation for setting the carriage 51 at the home position HP, performed when it is assumed that the carriage 51 is located at a position other than the home position HP. FIG. 11 is a schematic drawing for explaining another example of the control process for setting the carriage at the home position search start position ST.

### Step 11

The controller 100 moves the carriage 51 in the second direction DR2 by the fourth distance D4 (1064 pulses), and performs the black/white decision with respect to the read image. In the case of a color other than white, for example black, the controller 100 proceeds to step 12. At this point, it is theoretically impossible that the read image is decided as white. In the case of white, the controller 100 causes the display device 473 to display a message notifying occurrence of an error to the user.

### Step 12

The controller 100 moves the carriage 51 in the first direction DR1 by the fifth distance D5 (189 pulses), thereby bringing the carriage 51 closer to the first white reference plate 164. Then the controller 100 performs the black/white decision (fourth deciding operation) with respect to the read image, and repeats the operation of step 12 in the case of black, thereby bringing the carriage 51 still closer to the first white reference plate 164. In the case of white, it can be assumed that the carriage 51 has reached the first white reference plate 164, and therefore the controller 100 moves the carriage 51 in the second direction DR2 by the fifth distance D5 (189 pulses), thereby locating the carriage 51 on the downstream side of the first white reference plate 164 in the sub scanning direction, and proceeds to step 13.

### Step 13

The controller 100 defines the current position of the carriage 51 as the home position search start position ST, and moves the carriage 51 in the first direction DR1 by 2 pulses. Then the controller 100 performs the black/white decision (first deciding operation) with respect to the read image, and moves the carriage 51 in the direction DR1 by the first distance D1 (48 pulses), in the case of white. At this point, the positioning of the carriage 51 at the home position HP is completed. In the case of a color other than white, for example black, the controller 100 repeats the operation of step 13.

The positioning operation described with reference to FIG. 10 and FIG. 11 is performed when it is uncertain whether the carriage 51 has been stopped at the home position HP. As an example of such a situation, the number of times of the black/white decision (black/white detection), performed before the carriage 51 is set at the home position HP, will be described, with reference to the case where the carriage 51 is set at the home position HP, when the power to the image forming apparatus 1 is turned on.

The controller 100 performs the black/white decision once, after moving the carriage 51 as step 11 (1064 pulses, 45.04 mm). The carriage 51 is located at the position away from the downstream-side end portion DE1 of the first white reference plate 164 by approximately 43 mm (=45.04-2) to the downstream side, in the sub scanning direction, and the controller 100 detects the white image at the sixth movement as step 12 (189 pulses, 8.0 mm). Therefore, the black/white decision is performed six times.

The carriage 51 is moved toward the downstream-side end portion DE1 of the first white reference plate 164, in increments of 0.085 mm, with the position approximately 3 mm away from the downstream-side end portion DE1 of the first white reference plate 164 defined as the home position search start position ST, and therefore the carriage 51 reaches the downstream-side end portion DE1 of the first white reference plate 164, at the 36th black/white decision (˜ 3 mm/0.085 mm). Consequently, the number of times of black/white decision in this case is 43 times (1+36+6).

In the case of deciding that the read image is not white in the second deciding operation, deciding that the read image is not white in the third deciding operation, or deciding that the read image is white in the fifth deciding operation, the controller 100 may perform the positioning operation, corresponding to the positioning operation for setting the carriage 51 at the home position HP, to be performed when it is uncertain whether the carriage 51 has been stopped at the home position HP as described above.

Now, in the case of returning the carriage to the home position, immediately after the image of the document placed on the contact glass has been read, moving the carriage in the opposite direction, by the same distance as the distance travelled from the home position during the reading operation, can theoretically return the carriage to the home position.

However, the excitation method of the stepping motor may be different, between the operation of the motor during the reading operation and the operation during the returning operation. For example, when W1-2 phase excitation is performed during the reading operation, and 1-2 phase excitation is performed during the returning operation, phase matching has to be performed. Without the phase matching, a phase shift is incurred, and it becomes difficult to accurately set the carriage at the home position, despite moving back the carriage by the same distance as the distance travelled during the reading operation.

In addition, although the carriage is once stopped at the home position, it is preferable, for example at the timing that the operation mode is shifted from the energy-saving mode (e.g., sleep mode) to the normal mode, to perform the positioning of the carriage at the home position, in order to accurately detect the position of the carriage at the time of the mode shift.

In the case of the known positioning technique, an image sensor detects that the carriage has reached the boundary (white reference plate edge) between the white region (white reference plate) and the black region, and the carriage is set at the home position, by moving the carriage by a predetermined distance from the white reference plate edge, and stopping the carriage.

However, the mentioned known positioning technique may require a long time before the carriage is set at the home position. For example, when the carriage is away from the white reference plate edge by a long distance, the time required for the carriage to reach the white reference plate edge becomes very long.

With the configuration according to the foregoing embodiment, in contrast, the positioning of the carriage 51 at the home position HP can be accurately performed, without the need to provide a single-purpose sensor for detecting that the carriage 51 has reached the home position HP. In addition, the positioning of the carriage 51 at the home position HP is performed, after once locating the carriage 51 at the home position search start position ST, and therefore the time required for the positioning operation can be shortened. As result, the positioning of the carriage 51 at the home position HP can be accurately performed, without the need to provide the single-purpose sensor, and also the time required for the positioning operation can be shortened.

The disclosure may be modified in various manners, without limitation to the configuration according to the foregoing embodiment. Further, the configurations and processings described in the embodiments with reference to FIG. 1 to FIG. 11 are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims.

What is claimed is:

1. An image reading apparatus comprising:
a contact glass on which a document is placed;
a carriage including a light source that emits light to the document placed on the contact glass, along a main scanning direction, and configured to reciprocate along a sub scanning direction orthogonal to the main scanning direction, the carriage being located on a lower side of the contact glass, opposite to an upper face on which the document is placed;
a drive mechanism that moves the carriage in the sub scanning direction;
an imaging device that reads an image of the document placed on the contact glass, by receiving the light emitted from the light source and reflected;
a controller including a processor, and configured to move, when the processor executes a control program, the carriage in the sub scanning direction, thereby causing the imaging device to read the image of the document placed on the contact glass, by controlling an action of the light source, the drive mechanism, and the imaging device;
an outer peripheral member located along an outer periphery of the contact glass; and
a first white reference plate located inside a region occupied by the contact glass, with longitudinal sides extending in the main scanning direction, and overlapping with the outer peripheral member in a plan view,
wherein the first white reference plate is located at a position between an end portion of the contact glass and a document setting region on the contact glass, in the sub scanning direction, and
the controller is configured to:
control, in a case of positioning the carriage at a home position, defined inside a region occupied by the first white reference plate in the sub scanning direction, after causing the imaging device to read the image of the document placed on the contact glass, the action of the drive mechanism, thereby moving the carriage to a predetermined search start position, located on a side of the document setting region with respect to the region occupied by the first white reference plate, and stopping the carriage at the search start position;
execute, while moving the carriage in a first direction, from the search start position toward the region occupied by the first white reference plate, a first deciding operation including deciding, on a basis of image data on an outer side of the document setting region in the main scanning direction, sequentially read by the imaging device, whether a read image represented by the image data is white; and
execute a positioning operation including setting the carriage at the home position, by stopping the carriage, after moving the carriage from a position thereof when the read image was decided as white in the first deciding operation, by a predetermined first distance, corresponding to a length between a side edge of the first white reference plate on the side of the document setting region in the first direction, and the home position.

2. The image reading apparatus according to claim 1, further comprising a second white reference plate, spaced from the first white reference plate in the sub scanning direction, located on a side of the one end portion of the contact glass in the sub scanning direction, with respect to the first white reference plate, having longitudinal sides extending in the main scanning direction, and overlapping with the outer peripheral member in a plan view,
wherein, when positioning the carriage at the home position again, after stopping the carriage at the home position through the positioning operation, and before causing the imaging device to read the image of the document placed on the contact glass, the controller
executes a second deciding operation including deciding, on a basis of the image data on the outer side of the document setting region, read by the imaging device, whether the read image represented by the image data is white,
moves the carriage, upon deciding in the second deciding operation that the read image is white, in the first direction by a predetermined second distance, longer than a second length between the home position and a side edge of the second white reference plate on the side of the document setting region, and shorter than a sum of the second length and a first width of the second white reference plate in the sub scanning direction, and stops the carriage,
executes a third deciding operation including deciding, on a basis of the image data on the outer side of the document setting region, read by the imaging device, whether the read image represented by the image data is white, and
moves the carriage, upon deciding in the third deciding operation that the read image is white, in a second direction opposite to the first direction, by a predetermined third distance, longer than a sum of the second distance and the first length, and stops the carriage, and executes the first deciding operation and the positioning operation, with the stop position defined as the home position search start position.

3. The image reading apparatus according to claim 1,
wherein, in a case of positioning the carriage at the home position again, when it is uncertain whether the carriage has been stopped at the home position through the positioning operation, the controller
moves the carriage in a second direction opposite to the first direction, by a predetermined fourth distance longer than a third length between the one end portion of the contact glass and a side edge of the first white reference plate on the side of the document setting region, stops the carriage, and locates the carriage on the side of the document setting region with respect to the first white reference plate,
moves the carriage, after thus locating the carriage, in the first direction by a predetermined fifth distance shorter than a second width of the first white reference plate in the sub scanning direction, executing at a same time a fourth deciding operation including deciding, on a basis of the image data on the outer side of the document setting region, read by the imaging device, whether the read image represented by the image data is white,
moves the carriage, upon deciding in the fourth deciding operation that the read image is not white, in the first direction by the fifth distance again, and executes the fourth deciding operation again, and
moves the carriage in the second direction by the fifth distance and stops the carriage, upon deciding that the read image is white, and executes the first deciding operation and the positioning operation, with the stop position defined as the home position search start position.

4. The image reading apparatus according to claim 1,
wherein the controller calculates an average value of the image data of each color component, acquired from the imaging device, decides whether the calculated average value is equal to or higher than a predetermined threshold, set for deciding whether the read image is white, and decides whether the read image is white, on a basis of a decision with respect to the threshold.

5. An image forming apparatus comprising:
the image reading apparatus according to claim 1; and
an image forming device that forms the image acquired through the reading operation of the image reading apparatus, on a recording sheet.
